(19) United States
(12) Patent Application Publication
(10) Pub. No.: US 2009/0171471 A1
(43) Pub. Date: Jul. 2, 2009

(54) MONITORING AND CONTROL APPARATUS FOR COMPUTER NUMERICAL CONTROL MACHINES

(75) Inventor: Yue-Wen Chen, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXNUM TECHNOLOGY CO., LTD., Tucheng City (TW)

(21) Appl. No.: 12/048,232

(22) Filed: Mar. 14, 2008

(30) Foreign Application Priority Data
Dec. 27, 2007 (CN) 200710203475.0

(51) Int. Cl. G05B 19/18

(52) U.S. Cl. 700/2

(57) ABSTRACT

A monitoring and control apparatus for monitoring and controlling computer numerical control (CNC) machines. The monitoring and control apparatus includes a monitoring and control device, a movement control card, and a movement control daughter card. The movement control daughter card is connected between the movement control card and a movable portion of the CNC machine so the movement control card controls the movable portion of the CNC machine using the movement control daughter card. The movement control daughter card includes a plurality of movement signal interfaces, a microprocessor, and a wireless transmitter. The plurality of movement signal interfaces are connected to the CNC machine to receive a plurality of status signals from the CNC machine. The microprocessor is for storing the status signals. The wireless transmitter is for transmitting the status signals from the microprocessor to the monitoring and control device.

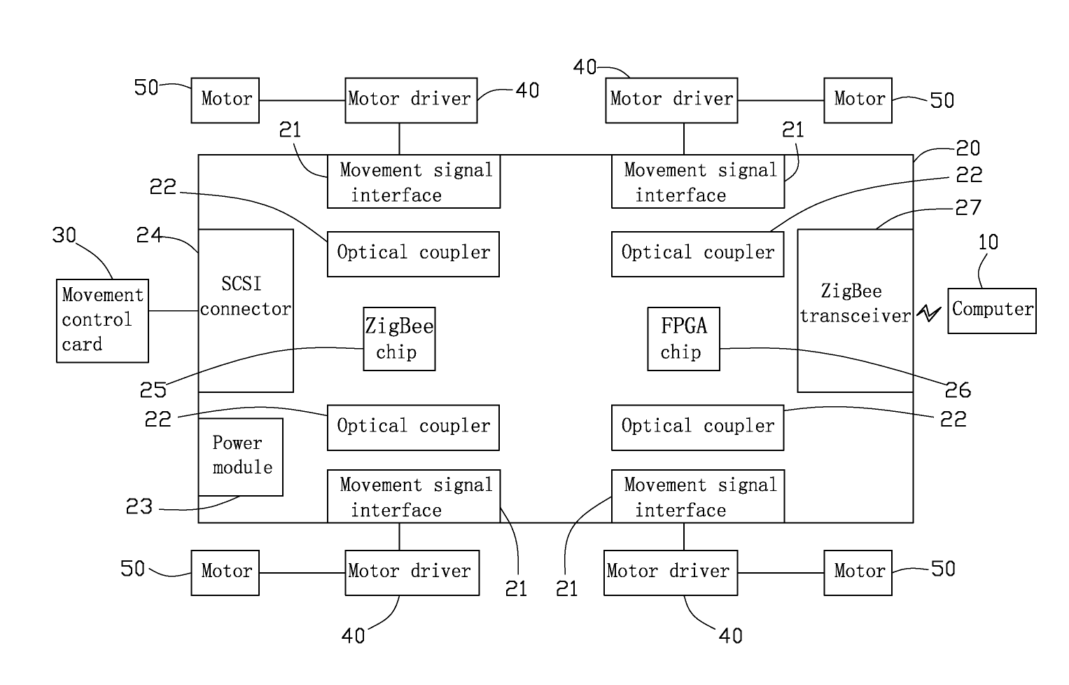

### BACKGROUND

1. Field of the Invention

The present invention relates to monitoring and control apparatus, and especially relates to a monitoring and control apparatus for computer numerical control (CNC) machines.

2. Description of Related Art

ZigBee is a mobile communication technology designed to be simpler and less power consuming than other wireless personal area networks (WPANs) such as a Bluetooth network. A ZigBee network generally costs only half as much to build as a typical Bluetooth network because less software and related parts are used, and it is especially ideal for use as a home network.

Conventionally, the CNC machines in a workshop are hardwired. It is common that computers in a monitoring center will need to monitor and control many CNC machines simultaneously, and the network of wiring needed for this is complex and difficult to achieve.

What is desired, therefore, is to provide a wireless monitoring and control apparatus for CNC machines.

### SUMMARY

An exemplary monitoring and control apparatus for monitoring and controlling computer numerical control (CNC) machines. The monitoring and control apparatus includes a monitoring device, a movement control card, and a movement control daughter card. The movement control daughter card is connected between the movement control card and a movable portion of the CNC machine so the movement control card controls the movable portion of the CNC machine using the movement control daughter card. The movement control daughter card includes a plurality of movement signal interfaces, a microprocessor, and a wireless transmitter. The plurality of movement signal interfaces are connected to the CNC machine to receive a plurality of status signals from the CNC machine. The microprocessor is for storing the status signals. The wireless transmitter is for transmitting the status signals from the microprocessor to the monitoring device.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is a block diagram of a monitoring and control apparatus for computer numerical control machines in accordance with an exemplary embodiment of the present invention.

### DETAILED DESCRIPTION

Referring to the drawing, a monitoring and control apparatus for monitoring and controlling computer numerical control (CNC) machines in accordance with an exemplary embodiment of the present invention includes a monitoring and control device 10, a movement control card 30, and a movement control daughter card 20.

The movement control daughter card 20 includes four movement signal interfaces 21, four optical couplers 22, a power module 23, a connector 24, a ZigBee chip 25, a microprocessor 26, and a ZigBee transceiver 27. Each movement signal interface 21 is connected to a movable portion of the CNC machine. Each movable portion of the CNC machine includes a motor driver 40 and a motor 50 driven by the motor driver 40.

In this embodiment, the monitoring and control device 10 is a computer. The microprocessor 26 is a field programmable gate array (FPGA) chip. The connector 24 is a small computer system interface (SCSI) connector.

The connector 24 of the movement control daughter card 20 is connected to the movement control card 30 for receiving instructions from the movement control card 30, and transmitting the instructions to the movement control daughter card 20 to control movement of the motors 50 through the movement signal interfaces 21, the optical couplers 22, and the motor driver 40. Each movement signal interface 21 of the movement control daughter card 20 receives status signals comprising X, Y, and Z coordinates indicating position of the corresponding motor 50, and a U coordinate indicating rotational position of a rotating part of the motor responsible for movement of the corresponding motor 50. The status signals are stored in the FPGA chip 26, and sent to the computer 10 through the ZigBee chip 25 and the ZigBee transceiver 27. The optical couplers 22 are provided for filtering of the signals. The optical couplers 22 may be omitted to save on costs.

In use, the movement control card 30 is installed in an industrial computer. The movement control daughter card 20 is installed in the numerical control device. The connector 24 of the movement control daughter card 20 receives instructions from the movement control card 30. The movement control daughter card 20 controls movement of the motors 50 according to the instructions. The status signals of the motors 50 are stored in the FPGA chip 26 through the movement signal interfaces 21 and the optical couplers 22, and sent to the computer 10 through the ZigBee chip 25 and the ZigBee transceiver 27. The computer 10 detects the status signals and displays the result to a user. In this way, the user may simultaneously monitor and control a plurality of CNC machines in a workshop with the computer 10 from a monitoring center.

In this embodiment, the computer 10 in the monitoring center monitors and communicates with the CNC machines in the workshop wirelessly. The monitoring apparatus replaces hardwire monitoring and control connections of CNC machines with the ZigBee wireless network. The computer 10 receives the status of the motors 50 and sends control instructions to the movement control daughter card 20 via the ZigBee wireless network. The monitoring and control apparatus is simple and low-cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A monitoring and control apparatus for monitoring and controlling computer numerical control (CNC) machines, the monitoring and control apparatus comprising:
a monitoring and control device for monitoring movement status of the CNC machines;
a movement control card; and
a movement control daughter card connected between the movement control card and a movable portion of the CNC machine so the movement control card controls the movable portion of the CNC machine using the movement control daughter card, the movement control daughter card comprising:
a plurality of movement signal interfaces connected to the CNC machine to receive a plurality of status signals from the CNC machine;
a microprocessor storing the status signals; and
a wireless transmitter for transmitting the status signals from the microprocessor to the monitoring and control device.

2. The monitoring and control apparatus as claimed in claim 1, wherein the wireless transmitter comprises a ZigBee chip and a ZigBee transceiver.

3. The monitoring and control apparatus as claimed in claim 1, wherein the daughter card further comprises a plurality of optical couplers, each optical coupler is connected to the movement signal interface for filtering of signals.

4. The monitoring and control apparatus as claimed in claim 1, wherein the daughter card comprises a connector connected to the movement control card, the connector is a small computer system interface connector.

5. The monitoring and control apparatus as claimed in claim 1, wherein the movement control card is installed in an industrial computer, the movement control daughter card is installed in the numerical control machine.

6. The monitoring and control apparatus as claimed in claim 1, wherein the plurality of movement signal interfaces comprise four movement signal interfaces respectively receiving movement status signals of movements in X-axis, Y-axis, and Z-axis and a rotation movement status signal of movement in U-axis.

7. The monitoring and control apparatus as claimed in claim 1, wherein the microprocessor is a field programmable gate array chip.

8. The monitoring and control apparatus as claimed in claim 1, wherein the monitoring and control device is a computer.

9. A movement control daughter card for a CNC machine connected between a movement control card and a movable portion of the CNC machine so the movement control card controls the movable portion of the CNC machine using the movement control daughter card, the movement control daughter card comprising:
a plurality of movement signal interfaces connected to the CNC machine to receive a plurality of status signals from the CNC machine;
a microprocessor storing the status signals; and
a wireless transmitter for transmitting the status signals from the microprocessor to a monitoring device.

10. The movement control daughter card as claimed in claim 9, wherein the wireless transmitter comprises a ZigBee chip and a ZigBee transceiver.

11. The movement control daughter card as claimed in claim 9, further comprising a plurality of optical couplers, wherein each optical coupler is connected to the movement signal interface for filtering of signals.

12. The movement control daughter card as claimed in claim 9, further comprising a connector connected to the movement control card, wherein the connector is a small computer system interface connector.

13. The movement control daughter card as claimed in claim 9, wherein the microprocessor is a field programmable gate array chip.

14. The monitoring apparatus as claimed in claim 9, wherein the plurality of movement signal interfaces comprise four movement signal interface respectively receiving movement status signals of movements in X-axis, Y-axis, and Z-axis and a rotation movement status signal of movement in U-axis.
